(19) United States
(12) Patent Application Publication
(10) Pub. No.: US 2026/0203682 A1
(43) Pub. Date: Jul. 16, 2026

(54) METHOD AND DEVICE FOR OPTIMAL SELECTION AND AVOIDANCE OF TESTING EXPERTS IN SCIENTIFIC AND TECHNOLOGICAL ACHIEVEMENT TESTING

(71) Applicant: NATIONAL INSTITUTE OF METROLOGY, CHINA, Beijing (CN)

(72) Inventors: Zhiwei SUI, Beijing (CN); Yihang XIE, Beijing (CN); Xinhua DAI, Beijing (CN); Yuning DUAN, Beijing (CN); Xiang FANG, Beijing (CN); Yu ZHENG, Beijing (CN); Zhijun YANG, Beijing (CN); Dabo LI, Beijing (CN); Chen LI, Beijing (CN)

(21) Appl. No.: 19/134,644

(22) PCT Filed: Dec. 14, 2023
(86) PCT No.: PCT/CN2023/138697

§ 371 Date: May 30, 2025

(30) Foreign Application Priority Data
Feb. 7, 2023 (CN) 202310070347.2

(51) Int. Cl. G06Q 10/0631

(52) U.S. Cl. CPC G06Q 10/063112

(57) ABSTRACT

Disclosed are a method and device for optimal selection and avoidance of testing experts in scientific and technological achievement testing. The method includes: Phase I, establishing an expert database formation model through machine learning based on data of previously conducted scientific and technological achievement testing; and Phase II, performing quantitative analysis based on expert information within the database, and ranking the experts based on their comprehensive scores. The device includes an expert database formation module, an expert information quantification module, a comprehensive expert score calculation module, a ranking module and a replacement module. The method and device leverage previous data to establish, through machine learning, a set of expert database formation model capable of forming associated expert databases based on the characteristics of scientific and technological achievements, and quantitative analysis is performed on expert information with avoidance parameters introduced to avoid help from acquaintances.

### TECHNICAL FIELD

The present invention relates to the field of data processing, particularly to a method and device for optimal selection and avoidance of testing experts in scientific and technological achievement testing.

### BACKGROUND

With the advancement of technology, an increasing number of scientific and technological achievements require third-party testing, and both the acceptance of scientific research projects and the commercialization of scientific and technological achievements necessitate third-party testing agencies to conduct testing on scientific and technological achievements and issue corresponding reports to demonstrate their actual performance.

The conventional selection of testing experts mostly relies on the discretionary choices of project leaders, which may lead to issues such as irrelevant research focus, insufficient testing experience and project partners, resulting in failure to conduct objective, impartial, scientific and accurate corresponding third-party testing on scientific and technological achievements, consequently being unable to acquire real conditions of the scientific and technological achievements.

Some recommended methods are also provided in the prior art, for example, CN108846056B discloses a method and device for recommendation of scientific and technological achievement review experts, CN201310509358.2 discloses a technology project-oriented intelligent review expert recommendation method, CN201410092584.X discloses a disciplinary eigenvalue algorithm and project review expert recommendation algorithm based thereon, and CN201410476082.7 discloses a method and device for project-professional matching. However, all the above-mentioned patents solely rely on keyword matching between scientific and technological achievements and experts to achieve expert recommendation, and only analyze from the single dimension of keyword matching. This leads to issues such as irrelevant actual research focuses and insufficient testing experience, making it impossible to recommend experts scientifically and reasonably. Moreover, these methods fail to consider the potential conflicts of interest between experts and the scientific and technological achievement owners, i.e., the existence of “greeting” phenomena due to familiarity-based collaboration, thus failing to conduct expert recommendation impartially and objectively.

Therefore, how to achieve scientifically rational quantitative analysis on various types of information of testing experts participating in scientific and technological achievement testing has become a critical issue requiring immediate resolution.

### SUMMARY

The objective of the present invention is to provide a method and device for optimal selection and avoidance of testing experts in scientific and technological achievement testing and evaluation. By setting the research focus, qualification capability, testing experience and activity level as relevant parameters, and setting relevant papers and relevant patents as avoidance parameters to analyze and quantify the relevant capabilities and avoidance capabilities of testing experts participating in testing and evaluation, the most suitable testing experts are selected by substituting these parameters into a set comprehensive score formula, thereby avoiding issues such as help from acquaintances and ensuring the scientific rationality, objectivity and fairness of the technological and scientific achievement testing. Also, an expert replacement mechanism is provided within the device, and if all top three ranked experts choose to refuse participation in the testing, they may jointly recommend an alternate expert until a recommended expert accepts the testing. This method is expected to address the limitations of conventional approaches where testing experts are selected at the subjective discretion of project leaders or testing institutions, or an acquaintance effect results in the inability to conduct thorough and accurate testing of scientific and technological achievements.

The present invention provides a method for optimal selection and avoidance of testing experts in scientific and technological achievement testing, with steps as follows:
establishing an expert database formation model through machine learning based on data of previously conducted scientific and technological achievement testing, so that associated expert databases can be formed based on key characteristics of scientific and technological achievements;
quantifying experts in the associated expert databases based on expert information, including research focus, qualification capability, testing experience, activity level, number of co-authored papers with the test subject, and number of co-invented patents with the test subject;
assigning values to quantitative parameters based on actual conditions of the experts, including research focus M, qualification capability N, testing experience O, activity level P, academic collaboration H, and patent collaboration I, and substituting these assigned values into the formula to calculate a comprehensive score K for each expert:

$$K = \frac{P}{10} {( NO - HI )}^{M} ,$$

and ranking the experts in the associated expert databases based on their comprehensive scores.

Optionally, if more than three experts refuse the invitations, they may jointly recommend other experts for replacement.

Preferably, the machine learning is specifically to perform tagged classification on scientific and technological achievement testing data kept previously, for example, over the past five years, using a Neo4j graph database, so that each tag serves as a node; all the data are input according to the above-mentioned processing to form an expert database of scientific and technological achievement testing; when the technical information of the tested scientific and technological achievements is input, an alternative expert panel for the current scientific and technological achievements can be formed.

Preferably, values are quantitatively assigned to experts within the associated expert database based on expert information, including research focus M, qualification capability N, testing experience O, activity level P, academic collaboration H, and patent collaboration I, and these assigned values are substituted into the formula to calculate a comprehensive scoreK for each expert:

$$K = \frac{P}{10} {( NO - HI )}^{M} ;$$

The experts are scored according to the formula of the comprehensive score K, and then optimal results are selected. Where if the result of (NO-HI) is negative;

Where, the research focus M is classified into three tiers: fully relevant (3 points), moderately relevant (2 points), and irrelevant (1 point), and more specifically, three corresponding research tags are established based on the testing experts' research focus during expert enrollment; when submitting technical information of scientific and technological achievements, clients will select three best-matching tags from the system's tag library with a technician's assistance; a score of 3 points is determined when the testing experts fully match all the three tags of the scientific and technological achievements, 2 points for two matches, and 1 point for one match and below;

The qualification capability N is classified into three tiers: 3 points for Senior Professional Title, 2 points for Associate Senior Title, and 1 point for all other cases;

The testing experience O is classified into three tiers: 3 points for national-level project leadership, 2 points for provincial/ministerial-level project leadership, and 1 point for all other cases;

The activity level P is classified into three tiers: 3 points for participation three or more times within one year, 2 points for participation twice, and 1 point for all other cases;

The paper-related H is classified into three tiers: information of the first three authors and corresponding authors from papers published by scientific and technological achievement owners over the past five years is collected and compared to that of a testing expert, a score of 3 points is determined if the testing expert has participated in three or more papers, 2 points for two papers, and 1 point for one paper and below;

The patent-related I is classified into three tiers: information of the first three authors from patents published by scientific and technological achievement owners over the past five years is collected and compared to that of a testing expert, a score of 3 points is determined if the testing expert has participated in three or more patents, 2 points for two patents, and 1 point for one patent and below.

The present invention also provides a device for optimal selection and avoidance of testing experts in scientific and technological achievement testing, including:
an expert database formation module, used to acquire associated expert databases based on the characteristics of the scientific and technological achievements;
an expert information quantification module, used to quantify the expert information within the associated expert database for subsequent calculation, including: analyzing the recorded expert information, and selecting the expert data to be quantified; selecting the research focus, qualification capability, testing experience and activity level for matching purposes; selecting the number of co-authored papers and co-authorized patents for quantification for avoidance purposes;
a comprehensive expert score calculation module, used to assign values to quantified parameters based on an expert's actual condition to obtain a comprehensive score K through calculation; and
a ranking module, used to rank the experts based on the comprehensive score K and initiate invitations based on the desired number of experts.

Further, a replacement module is also included: if more than three experts refuse the invitations, alternate experts may be jointly recommended by them for replacement.

Preferably, the expert database formation module includes:
allocating a training set, a validation set and a testing set based on scientific and technological achievement testing records historically kept over the past five years;
tagging the training set based on classification of the scientific and technological achievements, including source components, detectors and sensors, and tagging the names of participating testing experts;
each scientific and technological achievement has been tagged with the described category and the name of the expert who participated in the testing;
training the pre-established expert database formation model using the training set to obtain a trained expert database formation model, and subsequently optimizing the trained expert database formation model using the validation set and the testing set, thus obtaining a final expert database formation model.

### In Addition, Preferably, the Expert Information Quantification Module Includes:

an acquisition unit, used to acquire technical information of tested scientific and technological achievements, as well as element information of research focus M, qualification capability N, testing experience O, activity level P, paper-related H, and patent-related I of corresponding experts in the expert database based on the technical information; an assignment unit, used to assign values to quantitative values of testing experts' element information of research focus M, qualification capability N, testing experience O, activity level P, paper-related H, and patent-related I based on acquired relevant data;

Preferably, the research focus M is classified into three tiers: fully relevant (3 points), partially relevant (2 points) and irrelevant (1 point), and more specifically, three corresponding research tags are established based on the testing experts' research focus during expert enrollment; when submitting technical information of scientific and technological achievements, clients will select three best-matching tags from the system's tag library with a technician's assistance; a score of 3 points is determined when the testing experts fully match all the three tags of the scientific and technological achievements, 2 points for two matches, and 1 point for one match and below;

The qualification capability N is classified into three tiers: 3 points for Senior Professional Title, 2 points for Associate Senior Title, and 1 point for all other cases;

The testing experience O is classified into three tiers: 3 points for national-level project leadership, 2 points for provincial/ministerial-level project leadership, and 1 point for all other cases;

The activity level P is classified into three tiers: 3 points for participation three or more times within one year, 2 points for participation twice, and 1 point for all other cases;

The paper-related H is classified into three tiers: information of the first three authors and corresponding authors from papers published previously, for example, over the past five years, by scientific and technological achievement owners, is collected and compared to that of a testing expert, a score of 3 points is determined if the testing expert has participated in three or more papers, 2 points for two papers, and 1 point for one paper and below;

The patent-related I is classified into three tiers: information of the first three authors from patents published by scientific and technological achievement owners over the past five years is collected and compared to that of a testing expert, a score of 3 points is determined if the testing expert has participated in three or more patents, 2 points for two patents, and 1 point for one patent and below.

### Also Preferably, the Comprehensive Expert Score Calculation Module Includes:

a calculation unit, used to calculate the comprehensive score K of each testing expert, i.e., to calculate the comprehensive score K based on the extracted research focus M, qualification capability N, testing experience O, activity level P, academic collaboration H, and patent collaboration I of testing experts:

$$K = \frac{P}{10} {( NO - HI )}^{M} .$$

Further, the device also includes a display module configured to present the ranking results or recommendation results, e.g., presentation through displays, mobile terminals and the like.

### The Present Invention has the Following Innovations and Advantages:

Comprehensive and standard quantitative analysis system. The method and device provide a set of comprehensive and standard quantitative system for optimal selection and avoidance of testing experts in scientific and technological achievement testing based on actual conditions, which covers the research focus, qualification capability, testing experience and activity level, and the familiarity level between testing experts and scientific and technological achievement owners is judged based on ranking of authors in relevant papers and patents. This ensures that the selected testing experts meet the research focus of the scientific and technological achievements, and their qualification capability proficiency meets the testing requirements for the scientific and technological achievements, while avoiding the phenomenon of testing results being affected due to an acquaintance relationship.

Scientifically rational module design in the device. The device is divided into six major modules, each of which has detailed functions, these modules are rationally distributed and effectively coordinated, wherein the extraction module is further based on big data analysis, enabling rapid analysis and quantification of experts' capabilities to ensure accuracy in short time; the replacement module ensures contingency handling and uninterrupted progression of testing protocols, and provides an effective channel for expanding and renewing the expert database.

The present invention establishes a method and device for optimal selection and avoidance of testing experts in scientific and technological achievement testing, which methodologically avoids mismatches in research focus, mismatched capabilities and qualifications, help from acquaintances and the like involved in the process of scientific and technological achievement testing, and the device is designed with six major modules to ensure accurate quantitative analysis, smooth project implementation, and expansion of the expert database. The present invention effectively improves the working efficiency, avoids human subjectivity issues, and ensures the scientific rationality, fairness and objectivity of the scientific and technological achievement testing.

### BRIEF DESCRIPTION OF DRAWINGS

FIG. 1 illustrates a partial schematic diagram of expert database graph for scientific and technological achievements.

FIG. 2 illustrates a schematic diagram of an alternative expert panel.

FIG. 3 illustrates a schematic diagram of the device of the present invention.

### DETAILED DESCRIPTION OF EMBODIMENTS

In order to make the objectives, technical solution and advantages of the present invention clearer, the technical solution in the embodiments of the present application will be described clearly and completely below in conjunction with the accompanying drawings in the embodiments of the present application. Obviously, the embodiments described are only part of, rather than all of, the embodiments of the present application. The components of the embodiments of the present application, as generally described and shown in the accompanying drawings herein, may be arranged and designed in a variety of different configurations.

### Example 1

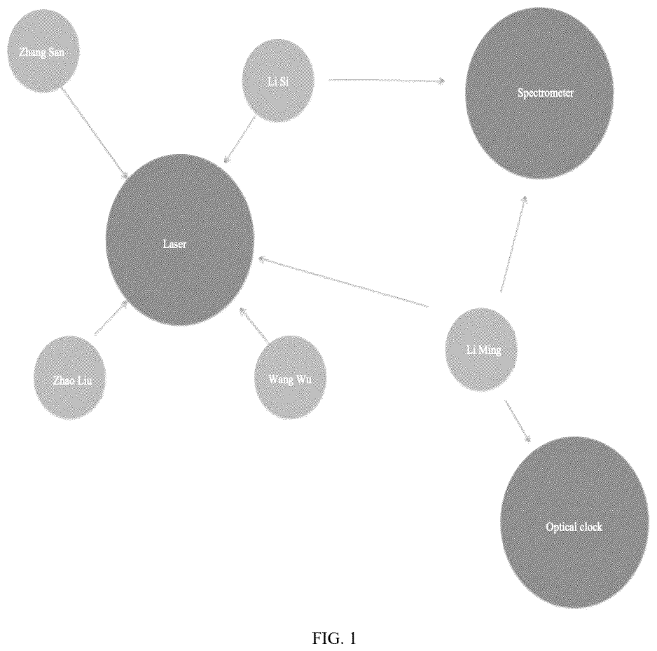

The present invention provides a method for optimal selection and avoidance of testing experts in scientific and technological achievement testing and evaluation, which is described as follows:
an expert database of scientific and technological achievement testing is established through machine learning, i.e., using a Neo4j graph database by performing tagged classification on scientific and technological achievement testing data kept over the past five years. The information in the database contains scientific and technological achievements information, expert information and the like, wherein the scientific and technological achievements information contains the names and tags of scientific and technological achievements, and the expert information includes personal information such as expert names and affiliated units. Specifically, the machine learning is specifically to perform tagged classification on scientific and technological achievement testing data kept previously, for example, over the past five years, using a Neo4j graph database, so that each tag serves as a node, for example, the XXX helium-neon laser is tagged as a laser that constitutes a node in the knowledge graph, and a triple <Laser, Test, Zhang San> (as shown in the partial schematic diagram of expert database graph for scientific and technological achievements in FIG. 1) is established through structured processing of data based on “Entity 1”−“Relationship”—“Entity 2”. All the data are processed and input as described above to form an expert database of scientific and technological achievement testing.

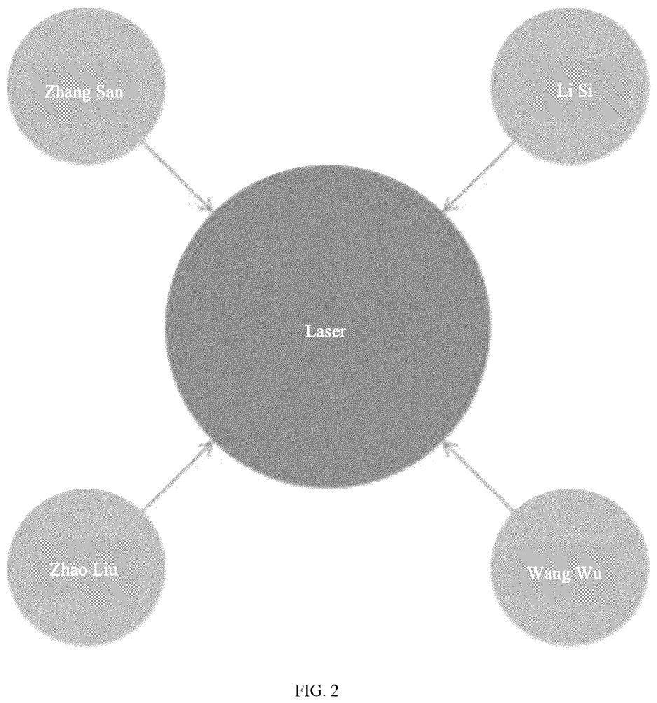

An alternative expert panel suitable for the current testing item can be obtained by acquiring the technical information of the scientific and technological achievements to be tested, tagging the characteristic values, and inputting these values into the database. For example, when scientific and technological achievements related to lasers are input, a schematic diagram of the alternative expert panel as shown in FIG. 2 can be formed.

Subsequently, a comparative analysis is performed on, for example, research focus M, qualification capability N, testing experience O, and activity level P based on the technical information of the scientific and technological achievements to be tested and the relevant capabilities of the experts in the alternative expert panel.

The research focus M is classified into three tiers: 3 points for fully relevant, 2 points for moderately relevant, and 1 point for irrelevant. Three corresponding research tags are established based on the testing experts' research focus during expert enrollment, the system will enter and establish a complete tag library in advance in order to prevent tag confusion, and the testing experts may select three tags that match their research focuses from the tag library. Subsequently, when submitting technical information of scientific and technological achievements, clients will select three best-matching tags from the system's tag library with a technician's assistance. A score of 3 points is determined when the testing experts fully match all the three tags of the scientific and technological achievements, 2 points for two matches, and 1 point for one match and below.

The qualification capability N is classified into three tiers: 3 points for Senior Professional Title, 2 points for Associate Senior Title, and 1 point for all other cases.

The testing experience O is classified into three tiers: 3 points for national-level project leadership, 2 points for provincial/ministerial-level project leadership, and 1 point for all other cases.

The activity level P is classified into three tiers: 3 points for participation three or more times within one year, 2 points for participation twice, and 1 point for all other cases.

A big data collection method is employed to collect published papers and granted patent information of the scientific achievements owners over the past five years, and the familiarity level between scientific achievements owners and testing experts is analyzed based on author ranking.

The paper-related H is classified into three tiers: information of the first three authors and corresponding authors from papers published by scientific and technological achievement owners over the past five years is collected and compared to that of a testing expert. A score of 3 points is determined if the testing expert has participated in three or more papers, 2 points for two papers, and 1 point for one paper and below.

The patent-related I is classified into three tiers: information of the first three authors from patents published by scientific and technological achievement owners over the past five years is collected and compared to that of a testing expert. A score of 3 points is determined if the testing expert has participated in three or more patents, 2 points for two patents, and 1 point for one patent and below.

To ensure rational scoring, the following factors are considered: M refers to the research focus, which is set as an exponential term to amplify its impact to ensure research alignment between testing experts and scientific and technological achievements; N and O refer to qualification capability and testing experience respectively, both serving as credit factors for experts and belonging to positive correlations; H and I represent co-authored papers and co-invented patents between the expert and the scientific and technological achievement owner respectively, and they are used to indicate familiarity levels. Since all these score values are positive, the term “−HI” is used in the formula, higher H and I scores indicate higher degrees of acquaintance, while the prefix “-” denotes a debit factor, thus achieving the effect of avoidance; P represents the activity level, which is considered in expert selection, but this does not imply that more active experts are necessarily more capable. Also, values of these items are selected based on three tiers “1, 2, 3”. Therefore, P/10 is selected in order to mitigate the impact of the activity level on the final K. The resulting comprehensive score K formula is as follows:

$$K = \frac{P}{10} {( NO - HI )}^{M} ,$$

The experts are scored according to the comprehensive score K formula, and then optimal results are selected. Where, if the result of (NO-HI) is negative, i.e., the calculated result of (NO-HI) is less than 0, this indicates an acquaintance relationship between this testing expert and the tested scientific and technological achievement owner, which should be avoided, and subsequent calculations should be discontinued.

The so-called avoidance is defined as an exclusion of testing experts in a potential acquaintance relationship in the present invention based on their comprehensive score K in order to avoid biased testing results due to the acquaintance relationship existing between the testing expert and the scientific and technological achievement owner during testing. A testing expert's name encountered among the first three authors or corresponding authors in papers or patents related to the tested scientific and technological achievements is generally regarded as indicative of an acquaintance relationship between the testing expert and the scientific and technological achievement owner. The degree of “acquaintance relationship” is determined based on the result of (NO-HI) in the K formula, where H and I quantify whether the testing expert has co-authored papers and co-invented patents with the scientific and technological achievement owner respectively, while N and O represent the testing expert's qualification capability and testing experience. If the result of (NO-HI) is negative, this indicates a significant degree of acquaintance between this expert and the tested scientific and technological achievements, then this expert should be excluded directly to fulfill the avoidance function.

### Examples are as Follows:

For a scientific achievement participation test, with research focus tags of optical radiation, ultraviolet spectroscopy, and instrument measurement & control, the capabilities of four experts were counted based on the technical information of the scientific and technological achievement, as shown in Table 1. Subsequently, scoring was performed based on analytical quantification principles, as shown in Table 2.

TABLE 1
Relevant information of testing experts A, B, C and D

| | A | B | C | D |
|---|---|---|---|---|
| Research | Optical | Optical | Instrument | Optical |
| focus M | radiation | radiation | measurement & | radiation |
| | Ultraviolet | Infrared remote | control | Ultraviolet |
| | spectroscopy | sensing | Physical optics | spectroscopy |
| | Instrument | Physical optics | Photonphysics | Instrument |
| | measurement & | | | measurement & |
| | control | | | control |
| Qualification | Senior | Associate Senior | Associate Senior | Senior |
| capability N | Professional | Title | Title | Professional |
| | Title | | | Title |
| Testing | National- | Provincial/ | Provincial/ | National- |
| experience O | level project | ministerial- | ministerial- | level project |
| | leadership | level project | level project | leadership |
| | | leadership | leadership | |
| Activity | Three times | Four times | Five times | Twice |
| level P | | | | |
| Paper- | None | None | None | Three papers |
| related H | | | | |
| Patent- | None | None | None | Two patents |
| related I | | | | |

TABLE 2
Quantitative scores of information related
to testing experts A, B, C, and D

| | A | B | C | D |
|---|---|---|---|---|
| Research focus M | 3 | 1 | 1 | 3 |
| Qualification capability N | 3 | 2 | 2 | 3 |
| Testing experience O | 3 | 2 | 2 | 3 |
| Activity level P | 3 | 3 | 3 | 2 |
| Paper-related H | 1 | 0 | 0 | 3 |
| Patent-related I | 0 | 0 | 0 | 2 |
| Comprehensive score K | 218.7 | 1.2 | 1.2 | 5.4 |

It can be known from the results that Expert A should be selected as the testing expert for this scientific and technological achievement based on the following reasons: compared to Experts B and C, Expert A demonstrates a comparable activity level, an aligned research focus, superior qualification capabilities, and richer testing experience; compared to Expert D, Expert A demonstrates a comparable performance in research focus, qualification capability, testing experience and activity level. However, Expert D has more co-authored papers and co-granted patents with the scientific and technological achievement owner, a conflict of interest is determined between them, and they constitute an acquaintance relationship. Consequently, avoidance should be initiated.

This method can effectively address the problem of a degree of matching between testing experts and scientific and technological achievements, while effectively avoiding acquaintance relationships to ensure the scientific rationality, fairness and objectivity of testing processes.

### Example 2

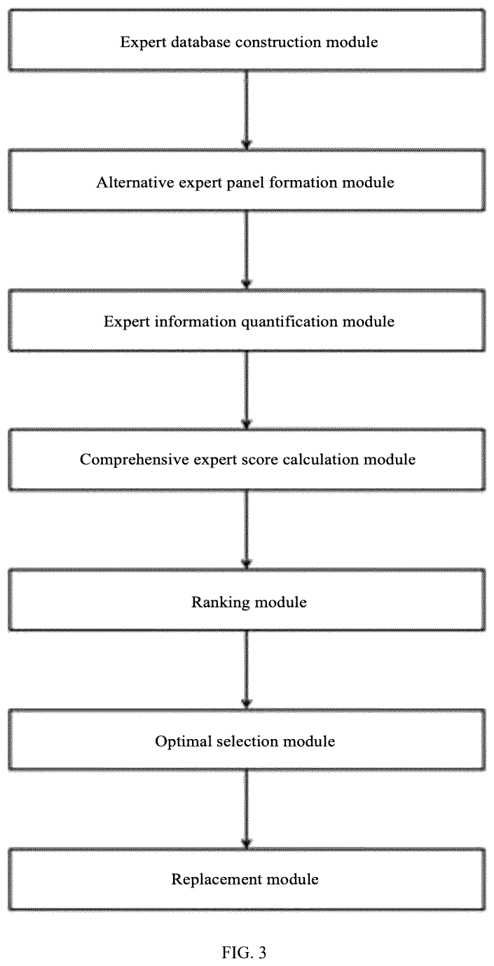

Corresponding to the method in Example 1, the present invention provides a device for optimal selection and avoidance of testing experts in scientific and technological achievement testing and evaluation (as shown in FIG. 3), consisting of the following components:
an expert database construction module, used to construct an expert database of scientific and technological achievement testing using a Neo4j graph database through machine learning based on scientific and technological achievement testing data kept over the past five years;
an alternative expert panel formation module, forming an alternative panel of testing experts based on the technical information of the scientific and technological achievements;
an expert information quantification module, used to quantify the expert information within the candidate team for subsequent calculation, including: analyzing the recorded expert information, and selecting the expert data to be quantified; selecting the research focus, qualification capability, testing experience and activity level for matching purposes; selecting the number of co-authored papers and co-authorized patents for quantification for avoidance purposes;
a comprehensive expert score calculation module, used to assign values to quantified parameters based on an expert's actual condition to obtain a comprehensive score K through calculation;
a ranking module, used to rank the experts based on the comprehensive score K and initiate invitations based on the desired number of experts.
an optimal selection module: selects the required number of experts based on the ranking results.
a replacement module: if all top three ranked experts choose to refuse participation in the testing, an alternate expert may be jointly recommended by them until a recommended expert accepts the testing.

All the above-mentioned functional modules may be integrated into a single processing unit, or exist as physically separate units, or two or more units may be integrated into a single unit.

When implemented as functional software units and sold or used as standalone products, the functions may be stored in a processor-executable nonvolatile computer-readable storage medium. Based on this understanding, the technical solution of the present application, in essence, or portions that contributes to the prior art, or part of the technical solution, may be embodied in the form of a software product. This computer software product is stored in a storage medium and includes several instructions used to cause a computer device (which may be a PC, server, or network instrument/device and the like) to execute all or part of the steps in the methods according to the embodiments of the present application. The aforementioned storage media include various media capable of storing program codes, such as USB flash drives, mobile hard disk drives, read-only memories, random-access memories, magnetic disks and CDs.

The above-mentioned embodiments are merely a detailed description of the embodiments of the present application, used to illustrate, rather than to limit, the technical solution of the present application, and the protection scope of the present application is not limited thereto. Although the present application is described in detail with reference to the above-mentioned embodiments, those of ordinary skills in the art should understand that: within the technical scope disclosed in the present application, any technician familiar with this technical field may still modify the technical solutions documented in the aforementioned embodiments, or readily conceive variations, or equivalently substitute some of the technical features; all these modifications, variations or substitutions, which do not cause the essence of a corresponding technical solution to depart from the spirit and scope of the technical solution in the embodiments of the present application, shall be covered within the protection scope of the present application.

1. A method for optimal selection and avoidance of testing experts in scientific and technological achievement testing, comprising the following steps:
establishing an expert database formation model based on data of previously conducted scientific and technological achievement testing, so that associated expert databases can be formed based on key characteristics of scientific and technological achievements;
quantifying experts in the associated expert databases based on expert information, comprising research focus, qualification capability, testing experience, activity level, number of co-authored papers with the test subject, and number of co-invented patents with the test subject;
assigning values to quantitative parameters based on actual conditions of the experts, comprising research focus M, qualification capability N, testing experience O, activity level P, academic collaboration H, and patent collaboration I, and substituting these assigned values into the formula to calculate a comprehensive score K for each expert:
$$K = \frac{P}{10} {( NO - HI )}^{M} ,$$
ranking the experts in the associated expert databases based on their comprehensive scores.

2. The method according to claim 1, wherein if more than three experts refuse invitations, they may jointly recommend other experts for replacement.

3. The method according to claim 1, wherein the establishing of an expert database formation model is to perform tagged classification on scientific and technological achievement testing data kept previously, for example, over the past five years, using a Neo4j graph database, so that each tag serves as a node; all the data are input according to the above-mentioned processing to form an expert database of scientific and technological achievement testing; when the technical information of the tested scientific and technological achievements is input, an alternative expert panel for the current scientific and technological achievements can be formed.

4. The method according to claim 1, wherein values are quantitatively assigned to experts within the associated expert databases based on expert information, comprising research focus M, qualification capability N, testing experience O, activity level P, academic collaboration H, and patent collaboration I, and these assigned values are substituted into the formula to calculate a comprehensive score K for each expert:
$$K = \frac{P}{10} {( NO - HI )}^{M} ;$$
the experts are scored according to the comprehensive score K formula, and then optimal results are selected. Where if the result of (NO-HI) is negative;
wherein, the research focus M is classified into three tiers: fully relevant (3 points), moderately relevant (2 points), and irrelevant (1 point), and more specifically, three corresponding research tags are established based on the testing experts' research focus during expert enrollment;
When submitting technical information of scientific and technological achievements, clients will select three best-matching tags from the system's tag library with a technician's assistance; a score of 3 points is determined when the testing experts fully match all the three tags of the scientific and technological achievements, 2 points for two matches, and 1 point for one match and below;
the qualification capability N is classified into three tiers: 3 points for Senior Professional Title, 2 points for Associate Senior Title, and 1 point for all other cases;
the testing experience O is classified into three tiers: 3 points for national-level project leadership, 2 points for provincial/ministerial-level project leadership, and 1 point for all other cases;
the activity level P is classified into three tiers: 3 points for participation three or more times within one year, 2 points for participation twice, and 1 point for all other cases;
the paper-related H is classified into three tiers: information of the first three authors and corresponding authors from papers published by scientific and technological achievement owners over the past five years is collected and compared to that of a testing expert, a score of 3 points is determined if the testing expert has participated in three or more papers, 2 points for two papers, and 1 point for one paper and below;
the patent-related I is classified into three tiers: information of the first three authors from patents published by scientific and technological achievement owners over the past five years is collected and compared to that of a testing expert, a score of 3 points is determined if the testing expert has participated in three or more patents, 2 points for two patents, and 1 point for one patent and below.

5. A device for optimal selection and avoidance of testing experts in scientific and technological achievement testing, characterized int that, comprising:
an expert database formation module, used to acquire associated expert databases based on the characteristics of scientific and technological achievements;
an expert information quantification module, used to quantify the expert information within the associated expert database for subsequent calculation, comprising: analyzing the recorded expert information, and selecting the expert data to be quantified; selecting the research focus, qualification capability, testing experience and activity level for matching purposes; selecting the number of co-authored papers and co-authorized patents for quantification for avoidance purposes;
a comprehensive expert score calculation module, used to assign values to quantified parameters based on an expert's actual condition to obtain a comprehensive score K through calculation; and
a ranking module, used to rank the experts based on the comprehensive score K and initiate invitations based on the desired number of experts.

6. The device according to claim 5, wherein the device further comprises a replacement module: if more than three experts refuse invitations, alternate experts may be jointly recommended by them for replacement.

7. The device according to claim 5, wherein the expert database formation module comprises:
allocating a training set, a validation set and a testing set based on scientific and technological achievement testing records historically kept over the past five years;
tagging the training set based on the classification of the scientific and technological achievements, including source components, detectors and sensors, and tagging the names of participating testing experts;
each scientific and technological achievement has been tagged with the described category and the name of the expert who participated in the testing;
training the pre-established expert database formation model using the training set to obtain a trained expert database formation model, and subsequently optimizing the trained expert database formation model using the validation set and the testing set, thus obtaining a final expert database formation model.

8. The device according to claim 5, wherein the expert information quantification module comprises:
an acquisition unit, used to acquire technical information of tested scientific and technological achievements, and acquire element information of research focus M, qualification capability N, testing experience O, activity level P, paper-related H, and patent-related I of corresponding experts in the expert database based on the technical information;
an assignment unit, used to assign values to quantitative values of testing experts' element information of research focus M, qualification capability N, testing experience O, activity level P, paper-related H, and patent-related I based on acquired relevant data;
Preferably, the research focus M is classified into three tiers: fully relevant (3 points), partially relevant (2 points) and irrelevant (1 point), and more specifically, three corresponding research tags are established based on the testing experts' research focus during expert enrollment;
when submitting technical information of scientific and technological achievements, clients will select three best-matching tags from the system's tag library with a technician's assistance; a score of 3 points is determined when the testing experts fully match all the three tags of the scientific and technological achievements, 2 points for two matches, and 1 point for one match and below;
the qualification capability N is classified into three tiers: 3 points for Senior Professional Title, 2 points for Associate Senior Title, and 1 point for all other cases;
the testing experience O is classified into three tiers: 3 points for national-level project leadership, 2 points for provincial/ministerial-level project leadership, and 1 point for all other cases;
the activity level P is classified into three tiers: 3 points for participation three or more times within one year, 2 points for participation twice, and 1 point for all other cases;
the paper-related H is classified into three tiers: information of the first three authors and corresponding authors from papers published previously, for example, over the past five years, by scientific and technological achievement owners, is collected and compared to that of a testing expert, a score of 3 points is determined if the testing expert has participated in three or more papers, 2 points for two papers, and 1 point for one paper and below;
the patent-related I is classified into three tiers: information of the first three authors from patents published by scientific and technological achievement owners over the past five years is collected and compared to that of a testing expert, a score of 3 points is determined if the testing expert has participated in three or more patents, 2 points for two patents, and 1 point for one patent and below.

9. The device according to claim 5, wherein the comprehensive expert score calculation module comprises:
a calculation unit, used to calculate the comprehensive score K of each testing expert, i.e., to calculate the comprehensive evaluation score K based on the research focus M, qualification capability N, testing experience O, activity level P, academic collaboration H, and patent collaboration I of extracted testing experts:
$$K = \frac{P}{10} {( NO - HI )}^{M} .$$

10. The device according to claim 5, wherein the device further comprises a display module configured to present the ranking results or recommendation results.
